(19) United States
(12) Patent Application Publication
(10) Pub. No.: US 2006/0110238 A1
(43) Pub. Date: May 25, 2006

(54) Washer device for preventing looseness

(76) Inventor: Takao Tsukui, Chofu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/544,028

(22) PCT Filed: Jan. 29, 2004
(86) PCT No.: PCT/JP04/00824

§ 371 Date: Jul. 29, 2005

(30) Foreign Application Priority Data
Jan. 29, 2003 (JP) 2003-057803

(51) Int. Cl. F16B 43/00

(52) U.S. Cl. 411/536

(57) ABSTRACT

A washer device for preventing looseness reduced in thickness, simplified in part configuration to lower cost, and capable of automatically compensating for looseness of a connection part, formed of a bolt and nut, due to aging, such as shrinkage of a connected member, so as to continuously and reliably preventing the looseness of the connection part. The washer device is for preventing looseness and includes a pair of washers, wherein at least one of the washers is a dome washer having a bolt insert hole. A circular elastic body having a power spring wound around the periphery is disposed in a gap between a spherical surface of the dome washer and an opposing surface, wherein the gap gradually narrows from the periphery toward the center. The power spring having an expanded diameter due to an expansion force caused by tightening is wound around in the gap like a snake by a restoring force. In this way, looseness of a screw due to shrinkage of the connected member is prevented by using the power spring as a wedge for maintaining the separation between the washers.

### TECHNICAL FIELD

The present invention relates to a device for preventing looseness in a connection part formed of a bolt and a nut and, more specifically, relates to a technology for automatically and continuously preventing looseness in the connection part due to aging, such as shrinkage of a connected member, such as wood.

### BACKGROUND ART

When a connection part formed of a bolt and a nut is used as a metal reinforcement in a wooden building, the connection part becomes loose several years after the completion of the building due to drying shrinkage of wood. As a result, the building's initial earth-quake resistance is lost.

Based on this, I have invented the washer device for preventing looseness disclosed in Japanese Unexamined Patent Application Publication No. 2001-280328 (previous invention). This previous invention provided a washer device for preventing looseness including a pair of circular washers and a power spring. A first circular washer was shaped as a convex lens with a hole in the center. The spherical surface of the first circular washer was joined with a surface of a second circular washer to form a gap between the first and second circular washers in manner such that the gap becomes narrower from the periphery toward the center. The power spring having nonslip treatment applied on its winding surface was wound around in the gap by the built-up restoring force. In this way, the power spring functioned as a wedge for separating the pair of circular washers so as to compensate for the shrinking of the wood.

However, the configuration of this previous invention included a large number of components. Also, the urging processes of the power spring, such as drilling holes, forming a protrusion, and stopping the expansion of the diameter, involved time and effort, causing an increase in costs. Furthermore, to prevent cross-sectional defects, a washer device thin and small as possible was desired when the washer device was to be seated in a counterbore of the connected member.

The present invention solves the above-mentioned problems and provides an inexpensive and highly reliable washer device for preventing looseness reduced in thickness, simplified in mechanism to reduce the number of components to enable a reduction in mass-production costs, and improved in the urging mechanism for the convex-lens-shaped washer and the power spring.

### DISCLOSURE OF INVENTION

A first aspect of the present invention provides a washer device for preventing looseness of a screw due to shrinkage of a connected member. The washer device includes a washer having a bolt insert hole, and a circular elastic body having a power spring wound around the periphery. The washer is a convex washer having a surface opposing the connected member. The diameter of the surface is reduced toward the protruding direction of the surface. The circular elastic body is interposed between the connected member and the convex washer. The looseness is prevented by compensating for the shrinkage by separating the connected member from the washer.

A second aspect of the present invention provides a washer device for preventing looseness of a screw due to shrinkage of a connected member. The washer device includes a pair of washers having bolt insert holes and a circular elastic body having a power spring wound around the periphery. At least one of the washers is a convex washer having a surface opposing the other washer. The diameter of the surface is reduced toward the protruding direction of the surface. The circular elastic body is interposed between the washers. The looseness is prevented by compensating for the shrinkage by separating the washers.

According to the first and second aspects of the present invention, looseness of a connection part due to aging, such as shrinkage of a connected member, such as wood, can be automatically and continuously prevented. The washer device can continuously maintain strong and stable resistance against large outside forces, such as earthquakes, for a long period of time. Therefore, the washer device according to the first and second aspects of the present invention achieves the same reliability as the previous invention. Furthermore, by carving out the inside of a convex washer, cost for press-molding can be reduced. By storing a nut in the depression on the back side of the dome washer, the height of the washer device can be reduced. In this way, the depth of a counterbore can be made shallow and cross-sectional defects can be reduced. Moreover, since the power spring does not have to be processed and the expansion force in a direction toward the periphery of the circular elastic body generated by compressing the circular elastic body by tightening the screw is utilized, the urging operation can be carried out in the field and additional tightening can be carried out after the washer device is installed and/or the washer device can be removed and reinstalled. Since the number of components can be reduced, cost can be reduced and shipment and installation is facilitated.

A third aspect of the present invention provides a washer device for preventing looseness of a screw due to shrinkage of a connected member. The washer device includes a pair of washers and a circular elastic body having a power spring wound around the periphery. At least one of the washers is a dome washer having a bolt insert hole. The power spring is disposed in a gap between a spherical surface of the dome washer and an opposing surface, wherein the gap gradually narrows from the periphery toward the center. The power spring having a diameter enlarged by the expansion force generated by tightening the screw is wound by a restoring force. The looseness is prevented by compensating for the shrinkage by separating the washers. Accordingly, since the power spring does not have to be processed and the expansion force in a direction toward the periphery of the circular elastic body generated by compressing the circular elastic body by tightening the screw is utilized, the urging operation can be carried out in the field and additional tightening can be carried out after the washer device is installed and/or the washer device can be removed and reinstalled.

The above-described circular elastic body also functions as a spring for supporting separation used for separating the pair of washers with a predetermined force so as to fully follow the gap formed by shrinkage of the connected member with the washer device. Depending on the material and temperature environment of the circular elastic body, there is a possibility that the circular elastic body will degrade in an early stage. However, this is not a problem since, in general, drying shrinkage of wood substantially stops in several years and by the time the circular elastic body starts to degrade the circular elastic body is not required any more.

The main component that resists outside forces over a long period of time is the power spring. Similar to the previous invention, when the washer device receives an outside force, such as an earthquake, the power spring interposed between the pair of washers receives pressure from both sides. Consequently, a force working to expand the circumference of the power spring by forcefully displacing each winding of the power spring from the inner side of the windings at pressure points on the spherical surface of the dome washer is applied. Since this frictional force is proportional to the pressure applied to the frictional surface, a great frictional force is generated due to pressure applied to the windings, contrary to the smooth movement of reducing the circumference of the power spring by loosening the windings in sequence from the inner side when the washer device follows the shrinkage of the wood. Due to the generation of friction, the power spring functions as a steel ring whose circumference cannot be easily expanded and continues to be disposed in the gap formed between the washers caused by the shrinkage of the connected member. For this reason, the washer device can maintain strong and stable resistance for a long period of time.

Since at least one of the washers is a dome washer having a bolt insert hole, mass-production is possible by press-molding. Furthermore, the thickness of the washer device can be reduced by including the thickness of the nut in the washer device by tightening the back side of the dome.

In addition to the above, the washer device according to one of the first to third aspects of the present invention uses the expansion force of urging means. Therefore, the washer device is capable of operating normally even when the tightening is stopped at a predetermined torque. Furthermore, the washer device can be used repeatedly by applying additional tightening to the washer device and by removing and reinstalling the washer device. The washer device can be easily handled since the power spring does not become unusable due to a reduction in the circumference of the power spring caused by shock. Since processing of the power spring and urging operation is not required, costs are reduced and the washer device can be provided at a low price. Furthermore, the washer device can be used as a shock absorber or a seismic isolator by changing its scale, strength, and/or installation method.

A washer device according to one of the fourth to eleventh aspects of the present invention, as described below, has a simplified mechanism. Since the washer device has a simple and reliable mechanism, the work required for urging and the number of components is reduced and installation is activated in conjunction with the normal action of tightening the screw. Consequently, costs are reduced and the washer device can be provided at a low price. The power spring of the washer device functions as a wedge in a similar manner as the washer device according to one of the above-described first, second, and third aspects of the present invention.

The fourth aspect of the present invention provides a washer device for preventing looseness of a screw due to shrinkage of a connected member. The washer device includes a washer having a bolt insert hole, a compression coil spring for supporting separation interposed between the connected member and the convex washer, and a power spring having a diameter enlarged against a diameter-shrinking force and being urged in a direction in which the diameter of the power spring is reduced. The washer is a convex washer having a surface opposing the connected member. The diameter of the surface is reduced toward the protruding direction of the surface. The looseness is prevented by compensating for the shrinkage by separating the connected member from the washer.

A fifth aspect of the present invention provides a washer device for preventing looseness of a screw due to shrinkage of a connected member. The washer device includes a pair of washers having bolt insert holes, a compression coil spring for supporting separation interposed between the washers, and a power spring having a diameter enlarged against a diameter-shrinking force and being urged in a direction in which the diameter of the power spring is reduced. At least one of the washers is a convex washer having diameter being reduced toward the tip facing the other washer. The compression coil spring is interposed between the washers. The looseness is prevented by compensating for the shrinkage by separating the washers.

A sixth aspect of the present invention provides a washer device for preventing looseness of a screw due to shrinkage of a connected member. The washer device includes a pair of washers, a compression coil spring for supporting separation interposed between a spherical surface of the washer and an opposing surface, and a circular hard base fit into the inner side of a power spring having a pre-enlarged diameter. At least one of the washers is a dome washer having a bolt insert hole. The power spring is urged in the direction in which the diameter of the power spring is reduced and is wound around in the gap by a restoring force. The looseness is prevented by compensating for the shrinkage by separating the washers.

A seventh aspect of the present invention provides a washer device having urging means for urging the power spring that is a circular band formed by connecting two ends. The circular band is engaged with the inner side of the power spring having a diameter expanded in advance.

An eighth aspect of the present invention provides a washer device having urging means for urging the power spring. The urging means includes a catch for engaging both ends of the power spring having a pre-enlarged diameter expanded and a hole formed on the washer for passing through the catch. Accordingly, the catch protrudes outward when installation is completed, and functions as a reminder of tightening.

A ninth aspect of the present invention provides a washer device having urging means for urging the power spring. The urging means includes a cover washer for pushing out the power spring having a pre-enlarged diameter and being wound around the periphery of the dome washer.

A tenth aspect of the present invention provides a washer device including a cylindrical connection member. Accordingly, the washer device including a plurality of components can be provided as a single unit, and thus shipment and installation is facilitated.

An eleventh aspect of the present invention provides a washer wherein one of the washers is a washer having a nut. Accordingly, work required for installation is reduced, and thus work efficiency is improved.

### BRIEF DESCRIPTION OF THE DRAWINGS

FIG. 1 is an exploded perspective view of a first embodiment of the present invention.

FIG. 2 is a cross-sectional view of the present invention before tightening.

FIG. 3 is a cross-sectional view of the present invention after tightened and installed.

FIG. 4 is a cross-sectional view of the present invention after following the shrinkage of the connected members.

FIG. 5 is a cross-sectional view of a variation of the present invention used for a different purpose to receive shock.

FIG. 6 is a cross-sectional view of a second embodiment of the present invention.

FIG. 7 is a perspective view of the main parts of the second embodiment of the present invention.

FIG. 8 is a cross-sectional view of a third embodiment of the present invention.

FIG. 9 is a perspective view of the main parts of the third embodiment of the present invention.

FIG. 10 is a cross-sectional view of a fourth embodiment of the present invention.

FIG. 11 is a perspective view of the main parts of the fourth embodiment of the present invention.

FIG. 12 is a cross-sectional view of a fifth embodiment of the present invention.

FIG. 13 is a perspective view of the main parts of the fifth embodiment of the present invention.

FIG. 14 is an exploded perspective view of a sixth embodiment of the present invention.

FIG. 15 is a cross-sectional view of the sixth embodiment of the present invention.

FIG. 16 is a cross-sectional view of a seventh embodiment of the present invention.

FIG. 17 is a cross-sectional view of an eighth embodiment of the present invention.

### BEST MODE FOR CARRYING OUT THE INVENTION

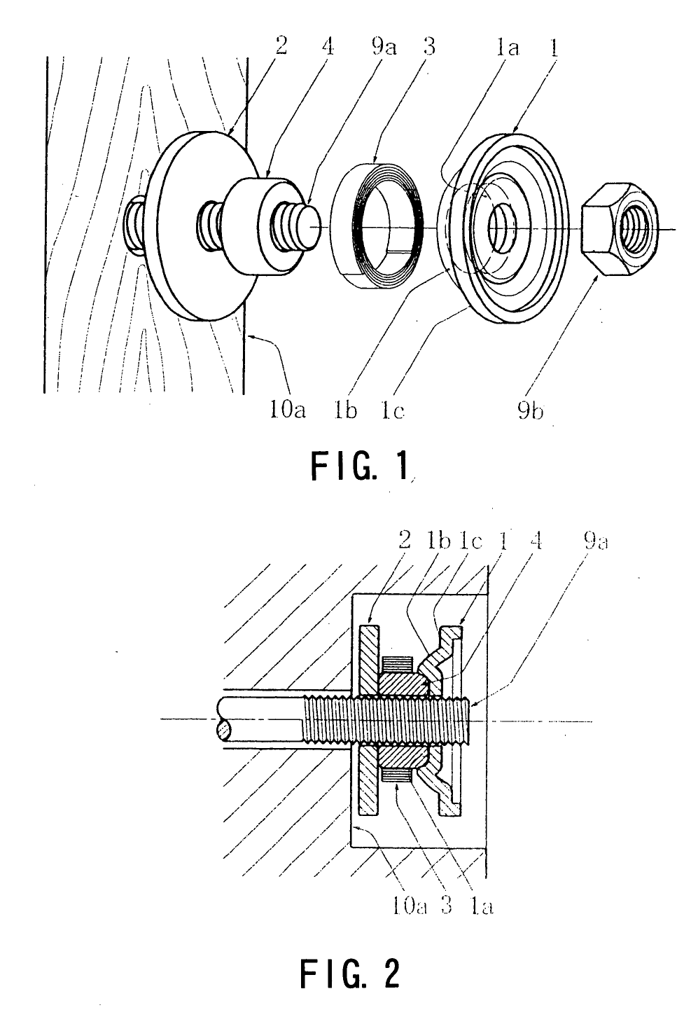

Embodiments of the present invention will be described with reference to the drawings. FIG. 1 is exploded perspective view of a first embodiment of the present invention. The drawing illustrates a washer device according to the first embodiment including a dome washer 1, a washer 2, a power spring 3, and a circular elastic body 4, wherein a bolt 9a penetrating through a connected member 10a is passed through these components and tightened by a nut 9b.

The dome washer 1, which is a first washer of a pair of washers included in the washer device, includes a depression 1a that is a connection part with the circular elastic body 4, a spherical surface 1b that includes the contact point with the power spring 3, and a flange 1c that makes up the periphery of the dome washer 1. The depression 1a does not have to include a depression and may be a flat surface or a spherical surface continuing from the spherical surface 1b. The circular elastic body 4 is a rubber elastic body. The circular elastic body 4 is made of natural and synthetic rubber materials and is formed into a ring having a predetermined thickness. By using a general-purpose rubber or a special rubber, the circular elastic body 4 has a predetermined hardness and degradation resistance.

It is desirable to provide corotation-prevention means on the contact surface of the washer 2 with the connected member. More specifically, a predetermined number of small protrusions or corrugated patterns may be provided on the contact surface with the connected member.

A stainless steel spring has been selected for the power spring 3 based on durability. The inner circumference of the power spring 3 at a normal state is substantially the same or smaller than the circumference of the circular elastic body 4. When the diameter of the power spring 3 is increased, the inner circumference of the power spring 3 becomes the same as the circumference of the dome washer flange 1c, the power spring 3 is wound a predetermined number of times, and the outer circumference of the power spring 3 becomes substantially the same as the circumference of the washer 2. It is desirable to diagonally cut off a small portion of a corner 31 of the inner end of the power spring 3, as illustrated in FIG. 14, so that the power spring 3 can smoothly enter into the V-shaped gap between the washers when the circumference of the power spring 3 is decreased. In such a case, the inner end of the power spring 3 is tapered. The width of the cut off portion is not limited. However, it is desirable to cut off about one third to one half around the inner circumference of the power spring 3.

FIG. 2 is a cross-sectional view of the inside of a counterbore before tightening the washer device. The power spring 3 in a substantially normal state is wound around the periphery of the circular elastic body 4 in abnormal state. Usually, the dome washer 1 and the washer 2 are bonded or burned on each side of the circular elastic body 4 to form a unit.

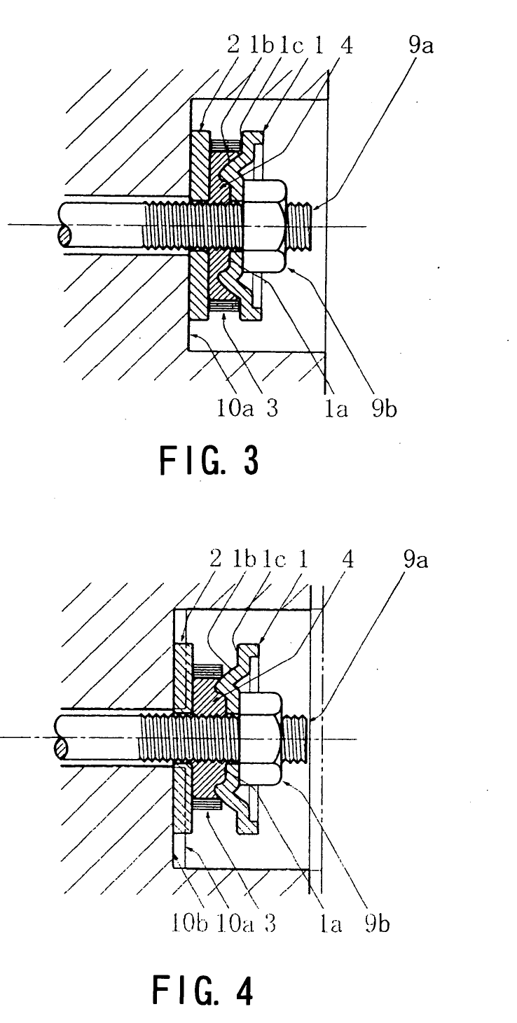

FIG. 3 is a cross-sectional view of the washer device inside a counterbore while being tightened. The circular elastic body 4 receives the axial force generated during installation by the rotation of the nut 9b. The penetration of the circular elastic body 4 is prevented on both sides by the pair of washers. As a result, the circular elastic body 4 is elastically deformed and expanded toward the periphery. The force of the expanding circular elastic body 4 causes the power spring 3 wound around circular elastic body 4 to be set at an increased circumference. The circular elastic body 4 has a predetermined volume so that the expansion stops at the flange 1c so as to match the width of the power spring 3 interposed between the dome washer flange 1c and the opposing washer. At this position, the power spring 3 functions as a stopper for preventing tightening. At this point, the installation of the washer device is completed.

A variable width set in accordance with the intended use can be adjusted by adjusting the diameter of the spherical surface of the dome washer 1, the height from the flange 1c, and the width of the power spring 3. The spring strength, the number of windings, and the hardness of the circular elastic body 4 can be changed. By combining these adjustments, an optimal washer device can be easily manufactured. Depending on the spring strength and the number of windings of the power spring 3, tightening might be difficult due to friction generated between the windings when the circumference is increase. However, by applying a weak soap solution or a volatile lubricant on the spring, friction generated between the windings can be reduced temporarily until the solution or lubricant dries. In this way, the operation can be carried out easily.

FIG. 4 is a cross-sectional view of the washer device disposed inside a counterbore when the washer device follows the shrinkage of the connected member. The drawing illustrates the connected member 10a being retracted to the position of a connected member 10b due to shrinkage. As a second role, the circular elastic body 4 separates the washers by a distance compensating for the shrinkage by deforming elastically due to a repulsive force, reducing the circumference, and restoring the thickness. Together with this, the circumference of the power spring 3 is reduced while the power spring 3 winds around like a snake and works into a V-shaped gap newly formed between the dome washer 1 and the washer 2 as a wedge. In this way, the external force can be firmly received.

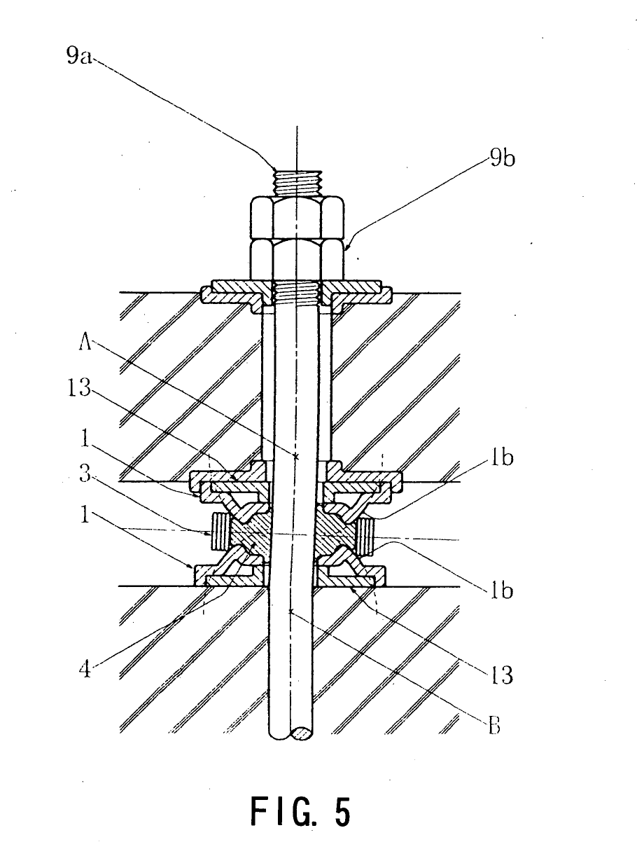

FIG. 5 is a cross-sectional view of a variation of the washer device used for a different purpose. The drawing illustrates the washer device being installed between connected members while vibration is applied, wherein the pair of washers is a pair of dome washers 1, the circular elastic body 4 on which the power spring 3 is wound around is interposed between the dome washers 1, and reinforcement washers 13 are engaged with the back sides the dome washers 1. In this case, the contact points of the power spring 3 and the dome washers 1 are on the spherical surfaces 1b. When vibration causes the shaft to contact the power spring 3, the power spring 3 absorbs the vibration by tilting and sliding on the spherical surfaces while being centered at the shaft from the center points of the sphere of both of the dome washers 1 (i.e., from points A to B in FIG. 5). Once the vibration is damped, the power spring 3 returns to a predetermined position by a restoring force generated by the repulsive elasticity of the bolt 9a and the circular elastic body 4.

In this way, the washer device can be used as a shock absorber or a seismic isolator by installing the washer device between hard materials that undergo less deterioration due to aging, such as steel and concrete, adjusting the scale of the washer device and the elastic strengths of the bolt 9a, the power spring 3, and the circular elastic body 4, retaining the torque applied to the washer device at a predetermined value, and using the washer device in a state of repulsive levitation. Depending on the elasticity of the bolt 9a, the washer device may be capable of establishing a joint-like connection.

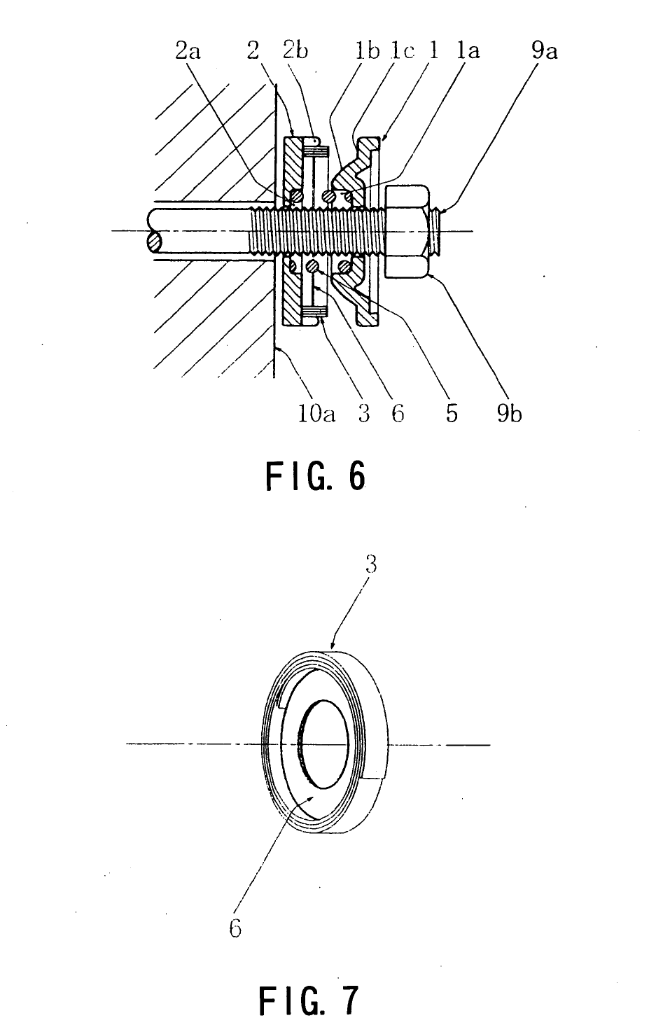

FIG. 6 is a cross-sectional view of a second embodiment of the present invention. The washer device according to the second embodiment includes a dome washer 1, a washer 2, a power spring 3, a compression coil spring 5, and a circular hard base 6. These components are assembled as a single unit by fitting the circular hard base 6 having a reduced thickness into the inner side of the power spring 3 having a pre-enlarged circumference to prevent shrinking of the circumference of the power spring 3, fixing the circular hard base 6 and the power spring 3 by fitting the two in the inner side of latches 2b provided in several points on the periphery of the washer 2, and matching a washer depression 2a with a dome washer depression 1a while the compression coil spring 5 is being interposed between the depressions. The compression coil spring 5 is capable of functioning as a connection member. FIG. 6 illustrates a state immediately before the washer device is being tightened. The dome washer 1 starts to move due to usual tightening. When the washer device is completely tightened, the circular hard base 6 is pushed out by the dome tip of the dome washer 1 and is disengaged. Then, the circumference of the power spring 3 shrinks, causing the power spring 3 to wind around in the V-shaped gap between the washers. At this point, the installation of the washer device is completed.

FIG. 7 is a perspective view of the main parts of this washer device. The outer diameter of the circular hard base 6 is set based on the thickness of the wound power spring 3 so that the power spring 3 engages with the inner side of a latch 1d of a flange 1c. The washer 2 side of the corner of the inner end of the power spring 3 is cut off diagonally by the same amount as the thickness of the circular hard base 6 so that the thickness of the circular hard base 6 does not interfere with the shrinking in the circumference of the power spring 3 when activated. It is desirable to bond several points on the circumference of the circular hard base 6 so that the circular hard base 6 does not easily detach due to shock.

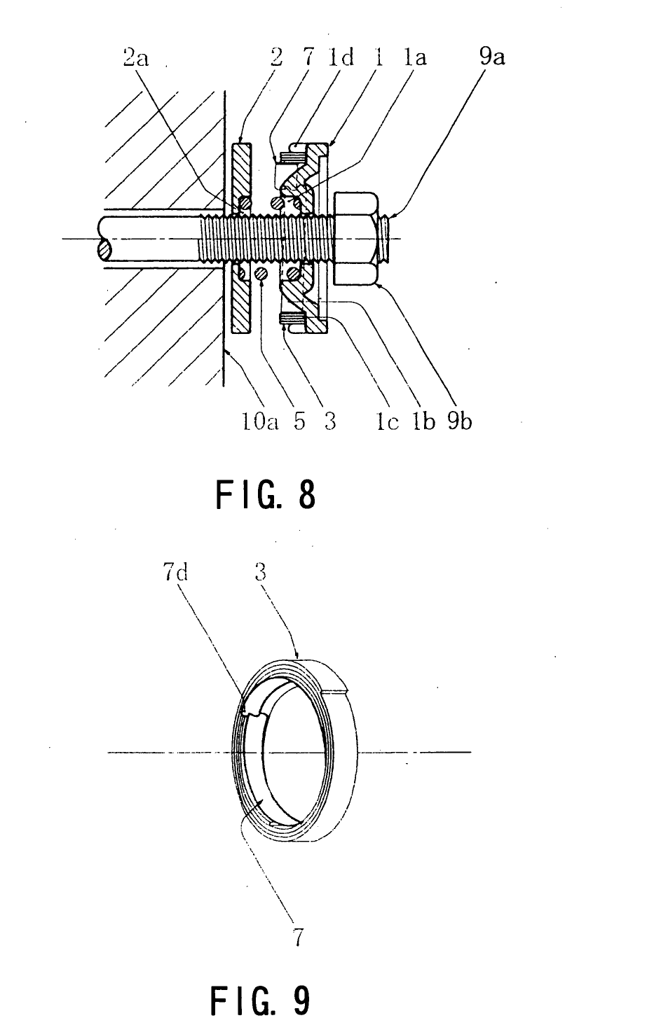

FIG. 8 is a cross-sectional view of a third embodiment of the present invention. The washer device according to the third embodiment includes a dome washer 1, a washer 2, a power spring 3, a compression coil spring 5, and a circular band 7. The circular band 7 is formed by connecting the ends in a misaligned manner. These components are assembled as a single unit by fitting the circular band 7 into the inner side of the power spring 3 having a pre-enlarged circumference to prevent shrinking of the circumference of the power spring 3, fixing the circular hard base 6 and the power spring 3 by fitting the two in the inner side of latches 1d provided in several points on the periphery of a dome washer flange 1c, and matching a washer depression 2a with a dome washer depression 1a while the compression coil spring 5 is being interposed between the depressions. FIG. 8 illustrates a state immediately before the washer device is being tightened. The dome washer 1 starts to move due to usual tightening. When the washer device is completely tightened, an engagement 7d of the circular band 7, where the ends of the circular band 7 are engaged in a misaligned manner, is pushed and disengaged. Then, the circumference of the power spring 3 shrinks, causing the power spring 3 to wind around in the V-shaped gap between the washers together with the circular band 7. At this point, the installation of the washer device is completed.

FIG. 9 is a perspective view of the main parts of this washer device. The ends of the circular band 7 are cut in S-shapes and the curved sections are staggeredly connected. When this circular band 7 is engaged with the power spring 3 as a hoop, one of the ends protrudes outward as a protrusion 7d and functions as an activation switch. The outer diameter of the circular band 7 is set based on the thickness of the wound power spring 3 so that the power spring 3 engages with the inner side of the latches 1d of the flange 1c. By using a ring-shaped flat spring having a width, thickness, and normal diameter slightly smaller than the power spring 3 as the circular band 7, the circular band 7 will not interfere with the shrinking of the circumference of the power spring 3 when the circular band 7 is disengaged.

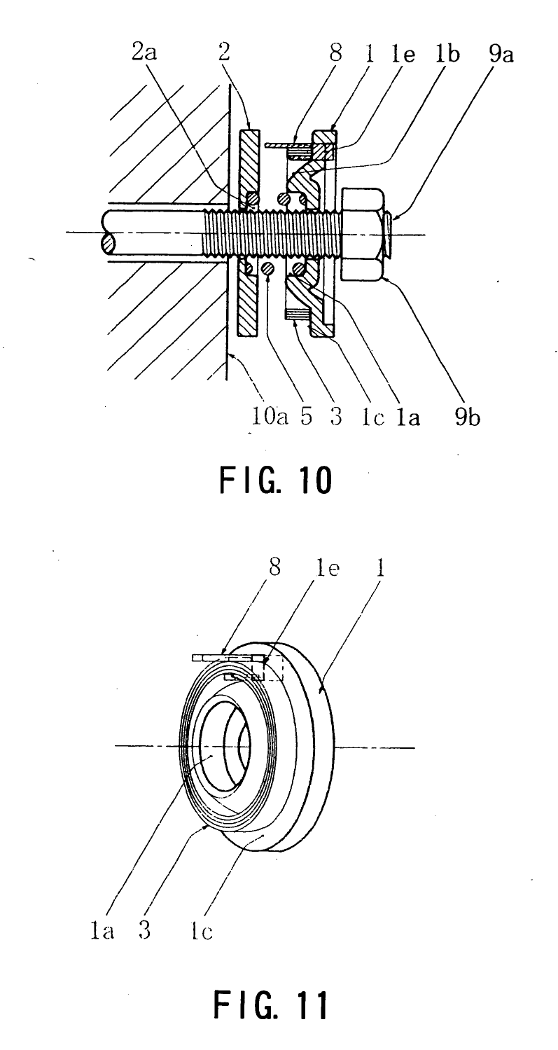

FIG. 10 is a cross-sectional diagram of a fourth embodiment of the present invention. The washer device according to the fourth embodiment includes a dome washer 1, a washer 2, a power spring 3, a compression coil spring 5, and a catch 8. These components are assembled as a single unit by engaging the catch 8 with the power spring 3 having a pre-enlarged circumference to prevent shrinking of the circumference of the power spring 3, passing the head of the catch 8 through a latching hole 1e formed on a flange 1c and fixing the catch 8, and matching a dome washer depression 1a with a washer depression 2a while the compression coil spring 5 is being interposed between the depressions. FIG. 10 illustrates a state immediately before the washer device is being tightened. The dome washer 1 starts to move due to usual tightening. Then, one of the legs of the catch 8 is pushed by the washer 2 and starts to fall out of the power spring 3 and the latching hole 1e. When the washer device is completely tightened, the catch 8 falls out from the latching hole 1e, causing the power spring 3 to be detached. Then, the circumference of the power spring 3 shrinks, causing the power spring 3 to wind around in the V-shaped gap between the washers together with the circular band 7. At this point, the installation of the washer device is completed.

FIG. 11 is a perspective view of the main parts of this washer device. The catch 8 is engaged with the power spring 3 in a manner such that the catch 8 clips the region where the inner and outer ends of the power spring 3 overlap. In this region, the rotational force caused by the shrinking of the circumference of the power spring 3 having a circumference enlarged to substantially the same circumference as the flange 1c is cancels out. By passing the catch 8 through a latching hole formed on the washer 2, both sides of the washer device can be used interchangeably.

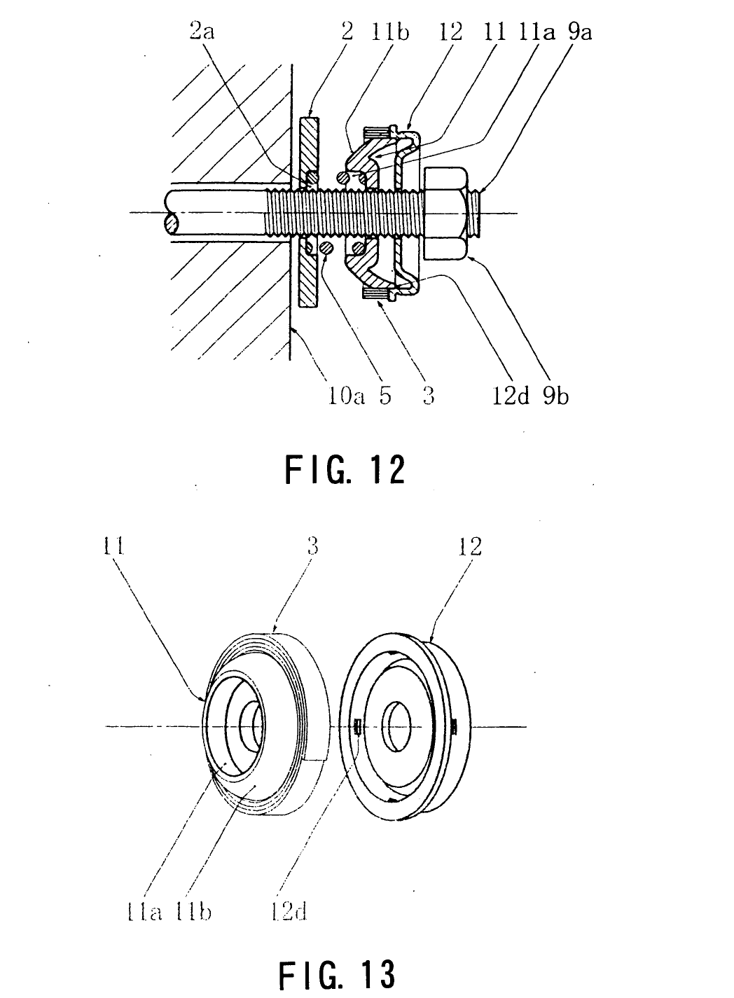

FIG. 12 is a cross-sectional view of a fifth embodiment of the present invention. The washer device according to the fifth embodiment includes a dome washer 11, a washer 2, a power spring 3, a compression coil spring 5, and a cover washer 12. These components are assembled as a single unit by winding the power spring 3 having a pre-enlarged circumference around the periphery of the dome washer 11 to prevent shrinking of the circumference of the power spring 3, engaging the cover washer 12 with the power spring 3 and the dome washer 11, and matching a dome washer depression 11a with a washer depression 2a while the compression coil spring 5 is being interposed between the depressions. FIG. 12 illustrates a state immediately before the washer device is being tightened. The dome washer 11 engaged with the cover washer 12 starts to move due to normal tightening and comes into contact with the washer 2. Then, the cover washer 12 starts to overlap with the dome washer 11, and the power spring 3 starts to move. When the washer device is completely tightened, the power spring 3 falls into the V-shaped gap between the washers and is wound around in the gap. At this point, the installation of the washer device is completed.

FIG. 13 is a perspective view of the main parts of this washer device. On the inner side of the cover washer 12, small protrusions 12d for latching the dome washer 11 are provided. The strength of the small protrusions 12d set in a range in which the small protrusions 12d resist the compression coil spring 5 but does not resist the tightening pressure. Therefore, while being tightened, the small protrusions 12d are sheared off and lock together with the dome washer 11 when the tightening is completed.

The above-described compression coil spring 5 may be replace by a plurality of disk springs or a cylindrical rubber elastic body having a repulsive force. Both sides of the washer device can be used interchangeably, and the washer device can be tightened from either side. However, if the connected member is soft, a washer for preventing embedment has to be provided on the back side of the dome washer 1 or the cover washer 12. On the other hand, if the connected member is hard and smooth, the washer 2 opposing the dome washer 1, i.e., a washer on the side of the connected member, may not be required.

It is desirable to form the washer 1 and/or the washer 2 as a dome shape. However, it is acceptable as long as the diameter of the opposing surface is reduced toward the protruding direction of the surface. Therefore, in addition to a dome shape, in which the ridgeline of the portion having a reduced diameter depicts a dome shape, the washers may be a linear shape, a concave arc shape, or a shape in which steps are formed at each predetermined diameter. It is desirable to carve out the inside of such a dome washer to form a depression.

It is desirable for the washer device according to the present invention to include a connection member connecting each component. The connection member integrates each component of the washer device, and, as illustrated in FIGS. 14 to 16, a cylindrical connection member 22 contacting and fitting around the periphery of the washers 1 and 2 or a cylindrical connection member 23 passed through the inner circumference of the washers 1 and 2, i.e., bolt holes if and 2f, may be used. The cylindrical connection members 22 and 23 are constituted of pipes or cylindrical films made of plastic, rubber, paper, or metal. Circular protrusions may be provided on the opposing surfaces of the washer 1 and 2 to engage with the bolt insert hole on the circular elastic body 4. In this way, the circular elastic body 4 can be used as a connection member. Moreover, an adhesive may be used as a connection member so that the washers 1 and 2 are spot-bonded to the circular elastic body 4.

As illustrated in FIG. 17, a washer 1 may be a washer with a nut. A cylindrical portion 191 extended from the head of a nut 19 is passed through a bolt insert hole 1f of the washer 1, and a flange 192 is provided at the tip of the cylindrical portion 191. In this way, the nut 19 is provided as a single unit with the washer 1 and is freely rotatable. The nut 19 may be pushed into the bolt insert hole 1f. The flange 192 may be formed after the nut 19 is pushed into the bolt insert hole 1f. The flange 192 may or may not be inserted into the bolt insert hole of the circular elastic body 4. Of course, the nut 19 may be fixed to the washer 1. If the circular elastic body 4 is used in such a case, it is desirable to prevent damage due to twisting of the circular elastic body 4 by providing a circular nonslip material between the washer 1 and the circular elastic body 4 in order to prevent transmission of the rotational force of the washer 1 to the circular elastic body 4.

### INDUSTRIAL APPLICABILITY

As described above, the washer device according to the present invention can be effectively used as a joining device capable of preventing looseness of a connection part of a metal reinforcement formed of a bolt and a nut used in buildings. In particular, it is suitable for use in areas where looseness of the connection parts occur due to aging, such as shrinking, of the connected parts, such as wood.

1. A washer device for preventing looseness of a screw due to shrinkage of a connected member, in which the looseness is prevented by compensating for the shrinkage by separating the connected member from the washer, comprising:
a washer having a bolt insert hole, the washer being a convex washer having a surface opposing the connected member, the diameter of the surface being reduced toward the protruding direction of the surface; and
a circular elastic body having a power spring wound around the periphery, the circular elastic body being interposed between the connected member and the convex washer.

2. A washer device for preventing looseness of a screw due to shrinkage of a connected member, in which the looseness is prevented by compensating for the shrinkage by separating the pair of washers, comprising:
a pair of washers having bolt insert holes, at least one of the washers being a convex washer having a surface opposing the other washer, the diameter of the surface being reduced toward the protruding direction of the surface; and
a circular elastic body having a power spring wound around the periphery, the circular elastic body being interposed between the pair of washers.

3. A washer device for preventing looseness of a screw due to shrinkage of a connected member, in which the looseness is prevented by compensating for the shrinkage by separating the pair of washers, comprising:
a pair of washers, at least one of the washers being a dome washer having a bolt insert hole; and
a circular elastic body having a power spring wound around the periphery, the power spring being disposed in a gap between a spherical surface of the dome washer and an opposing surface, the gap gradually narrowing from the periphery toward the center,
wherein the power spring having a diameter enlarged by the expansion force generated by tightening the screw is wound by a restoring force.

4. A washer device for preventing looseness of a screw due to shrinkage of a connected member, in which the looseness is prevented by compensating for the shrinkage by separating the pair of washers, comprising:
a washer having a bolt insert hole, the washer being a convex washer having a surface opposing the connected member, the diameter of the surface being reduced toward the protruding direction of the surface;
a compression coil spring for supporting separation interposed between the connected member and the convex washer; and
a power spring having a diameter enlarged against a diameter-shrinking force and being urged in a direction in which the diameter of the power spring is reduced.

5. A washer device for preventing looseness of a screw due to shrinkage of a connected member, in which the looseness is prevented by compensating for the shrinkage by separating the pair of washers, comprising:
a pair of washers having bolt insert holes, at least one of the washers being a convex washer having a surface opposing the other washer, the diameter of the surface being reduced toward the protruding direction of the surface;
a compression coil spring for supporting separation interposed between the pair of washers; and
a power spring having a diameter enlarged against a diameter-shrinking force and being urged in a direction in which the diameter of the power spring is reduced.

6. A washer device for preventing looseness of a screw due to shrinkage of a connected member, in which the looseness is prevented by compensating for the shrinkage by separating the pair of washers, comprising:
a pair of washers, at least one of the washers being a dome washer having a bolt insert hole;
a compression coil spring for supporting separation interposed between a spherical surface of the dome washer and an opposing surface; and
a circular hard base fit into the inner side of a power spring having a pre-enlarged diameter, the circular hard base being disposed in a gap gradually narrowing from the periphery toward the center,
wherein the power spring is urged in a direction in which the diameter of the power spring is reduced and is wound around in the gap by a restoring force.

7. The washer device for preventing looseness according to one of claims 4 to 6, wherein urging means for urging the power spring is a circular band formed by connecting two ends, the circular band being engaged with the inner side of the power spring having a pre-enlarged diameter.

8. The washer device for preventing looseness according to one of claims 4 to 6, wherein urging means for urging the power spring comprises a catch for engaging both ends of the power spring having a pre-enlarged diameter and a hole formed on the washer for passing through the catch.

9. The washer device for preventing looseness according to one of claims 4 to 6, wherein urging means for urging the power spring comprises a cover washer for pushing out the power spring, the power spring having a pre-enlarged diameter and being wound around the periphery of the dome washer.

10. The washer device for preventing looseness according to one of claims 1 to 6, the washer device further comprising:
a cylindrical connection member.

11. The washer device for preventing looseness according to one of claims 1 to 6, wherein one of the washers is a washer having a nut.
